(19) United States
(12) Patent Application Publication
(10) Pub. No.: US 2023/0291285 A1
(43) Pub. Date: Sep. 14, 2023

(54) ELECTRIC ROTATION MACHINE, METHOD FOR PRODUCING AN ELECTRIC ROTATION MACHINE, AND DRIVE SYSTEM EQUIPPED WITH THE ELECTRIC ROTATION MACHINE

(71) Applicant: Schaeffler Technologies AG & Co. KG, Herzogenaurach (DE)

(72) Inventors: Christian Silvery, Walzbachtal (DE); Thomas Niesen, Karlsruhe (DE); Peter Dietz, Waghäusel (DE); Matthias Kästle, Lauf (DE)

(73) Assignee: Schaeffler Technologies AG & Co. KG, Herzogenaurach (DE)

(21) Appl. No.: 18/018,317

(22) PCT Filed: Jul. 2, 2021
(86) PCT No.: PCT/DE2021/100570

§ 371 Date: Jan. 27, 2023

(30) Foreign Application Priority Data
Jul. 31, 2020 (DE) 10 2020 120 328.4

(51) Int. Cl. H02K 11/21; H02K 24/00

(52) U.S. Cl. CPC H02K 11/21; H02K 24/00

(57) ABSTRACT

An electric rotation machine comprises a rotor shaft and a rotor, which is arranged on the rotor shaft, of a rotor position sensor device. The electric rotation machine additionally has a static element, on which a stator of the rotor position sensor device is arranged, and a holding element, which is mechanically fixed to the static element and which blocks the translational degree of freedom of the stator of the rotor position sensor device in a first axial direction, wherein the translational degree of freedom of the stator of the rotor position sensor device is blocked by the static component in the opposite axial direction.

By virtue of the electric rotation machine, a method for producing the electric rotation machine and a drive system are provided which allow an inexpensive arrangement of the rotor position sensor device with the smallest possible required installation space and the lowest possible weight.

### CROSS-REFERENCE TO RELATED APPLICATIONS

This application is the U.S. National Phase of PCT Appln. No. PCT/DE2021/100570 filed Jul. 2, 2021, which claims priority to DE 102020120328.4 filed Jul. 31, 2020, the entire disclosures of which are incorporated by reference herein.

### TECHNICAL FIELD

The disclosure relates to an electric rotation machine, to a method for producing the electric rotation machine, and to a drive system for a motor vehicle equipped with the electric rotation machine.

### BACKGROUND

Electric drive machines are known from the prior art and are also increasingly being used in the automotive industry. Such a machine comprises a stator and a rotor rotatable in relation thereto. The rotor usually comprises a rotor shaft, balancing plates, laminated rotor cores, and magnets. The magnets are generally fixed in the laminated rotor cores.

In order to be able to detect the respective angular position of the rotor or individual components of the rotor with a high degree of accuracy, rotor position sensors are often used, the rotors of which are fixedly arranged in relation to the rotor. In this case, the rotor of the rotor position sensor is usually fixed to or on the shaft, which is fixedly connected to the rotor body. However, this type of arrangement requires a certain assembly effort after assembling the individual components of the rotor on the shaft. Furthermore, this design requires a corresponding amount of axial installation space. Particularly in the case of higher quantities, it must be ensured that the rotor of the rotor position sensor can be attached to or on the rotor shaft in a simple, time-saving and cost-efficient manner in order to maintain competitiveness.

In a conventional embodiment of an electric rotation machine equipped with a rotor position sensor, such as within a hybrid module, an electric axle, or a wheel hub equipped with an electric drive, the rotor position sensor is a resolver.

This resolver is required for commutation of the electric machine.

Here, the resolver stator is usually fixed to a housing of the electric rotation machine by means of several screws.

FIGS. 1 and 2 show conventional embodiments of a rotor position sensor device 10. FIG. 1 shows a rotor position sensor device 10, which is designed as an external rotor, so that the rotor 11 is located radially outside in relation to a radially inside stator 12. On the radial outer side of the stator 12, the latter has a region in which coils 13 are arranged.

FIG. 2 shows a rotor position sensor device 10, which is designed as an internal rotor, so that the rotor 11 is located radially inside the annular stator 12 or its region provided with coils 13.

Common to both embodiments shown in FIGS. 1 and 2 is that the stator 12 has openings 36 or holes that serve to mechanically attach the stator 12. It can be seen that these openings 36 have a certain radial space requirement, which increases the overall installation space of the rotor position sensor device 10 required.

Due to the high degree of integration within the electric rotation machine, in particular when it is designed as an electric axle, the installation space for all components and connections is severely limited in the axial and radial directions. In particular, the implementation of the connections of the components of the electric rotation machine inside the housing to contacts or connectors to the outside is associated with an increased constructive effort.

### SUMMARY

On this basis, the present disclosure is based on the object of providing an electric rotation machine, a method for producing the electric rotation machine and a drive system, which allow an inexpensive arrangement of the rotor position sensor device with the smallest possible required installation space and the lowest possible weight.

This object is achieved by the electric rotation machine according embodiments described herein, by the method for producing the electric rotation machine according embodiments described herein, and by the drive system according to embodiments described herein. Advantageous embodiments of the electric rotation machine are provided in the claims and disclosed throughout the disclosure.

The features of the claims can be combined in any technically meaningful way, with the explanations from the following description and features from the figures also possibly being used for this purpose, which include supplementary designs of the disclosure.

In the context of the present disclosure, the terms “radial” and “axial” always refer to the axis of rotation of the electric rotation machine.

The disclosure relates to an electric rotation machine, comprising a rotor shaft and a rotor, which is arranged on the rotor shaft, of a rotor position sensor device, wherein the electric rotation machine additionally has a static element, on which a stator of the rotor position sensor device is arranged. Furthermore, the electric rotation machine comprises a holding element, which is mechanically fixed to the static element and which blocks the translational degree of freedom of the stator of the rotor position sensor device in a first axial direction. The translational degree of freedom of the stator of the rotor position sensor device is blocked by the static component in the opposite axial direction.

The electric rotation machine can be designed, in particular, as an electric axle. It also has at least one rotor body on the rotor shaft, which comprises at least one laminated core and/or magnet.

The static element can be the stator or a housing of the electric rotation machine.

In particular, it is provided that the holding element is mechanically fixed to the static element in a detachable manner.

In one embodiment of the electric rotation machine, the rotor position sensor can be designed as a resolver.

The positioning and fixing of the stator of the rotor position sensor device by means of the holding element implements a cost-effective design of the electric rotation machine in terms of construction, which can be produced as part of a simple and time-saving assembly. Furthermore, the arrangement of the stator of the rotor position sensor device can be implemented in a very space-saving manner.

In particular, the stator of the rotor position sensor device is designed to be cylindrical on its radial outer side and therefore has no fixing devices or radially projecting regions for fixing. Due to this, this stator of the rotor position sensor device can be integrated in a simple manner with the least possible adaptation effort on different types of electric rotation machines or their stators.

The holding element, in turn, is easily adaptable to the respective restrictions in its shape and size.

In an advantageous embodiment, it is provided that the stator of the rotor position sensor device is arranged at least in regions in a radially formed shoulder of the static element.

This allows for a space-saving arrangement of the rotor position sensor or the stator, in particular if the rotor position sensor or the stator is arranged outside the windings of the electric rotation machine. Due to the space-saving arrangement, this embodiment allows the rotor position sensor to be integrated into a variety of different electric rotation machines.

In this regard, a surface of the shoulder arranged in a radially aligned plane can block the translational degree of freedom of the stator of the rotor position sensor device in the opposite axial direction. Thus, the holding element, together with the static element itself, provides for the axial fixation of the stator of the rotor position sensor device.

Furthermore, an axially aligned cylindrical surface of the shoulder can block the translational degree of freedom of the stator of the rotor position sensor device in the radial direction.

In other words, the stator of the rotor position sensor device is fitted into a cylindrical recess formed by the shoulder so that the stator of the rotor position sensor device is positioned and fixed in the radial direction in relation to the axis of rotation of the electric rotation machine and, consequently, is centered.

In particular, it is provided that the holding element is a metal sheet, which is mechanically fixed to the static element and which bears axially against the stator of the rotor position sensor device in regions. The holding element can be mechanically fixed to the static element by means of screw connections.

This means that the holding element is designed to be essentially two-dimensional, preferably in the form of essentially a circular ring.

Except for the bearing of the holding element against the stator of the rotor position sensor device, no further mechanical connection between the holding element and the stator of the rotor position sensor device is necessarily required.

Furthermore, in an advantageous embodiment, it is provided that the holding element has at least one axial projection, the compressive strength of which in the axial direction is lower than the flexural strength of the holding element in the radius of the arrangement of the axial projection.

The radius here refers to the radial distance in relation to the axis of rotation of the electric rotation machine.

Such an axial projection can be formed in particular as a punctual embossing or also as a punctual deep-drawing region. In the case of an elongated design, such an axial projection can also be referred to as a bead. This axially relatively soft projection has the function of compensating for axial dimensional and/or assembly tolerances of the static element and/or the stator of the rotor position sensor device, in that within the axial tolerance chain formed by the static element and the stator of the rotor position sensor device, in the case of minimum axial dimensions of the static element and the stator, the axial projection comes to bear against the stator of the rotor position sensor device and thus fixes it in an axial direction, and in the case of maximum axial dimensions of the static element and the stator, the axial projection is deformed as a result of compressive force to such an extent that it is still possible for the holding element to bear flat against the static element, with simultaneous bearing of the deformed axial projection against the stator of the rotor position sensor device in order to fix the latter in an axial direction.

Thus, axial tolerance compensation can be implemented by means of the axial projection, in particular several axial projections distributed around the circumference.

This effect is enhanced if an axially acting disc spring effect of the holding element is utilized.

In addition, the holding element can have a first engagement element and the stator of the rotor position sensor device can have a second engagement element, which is essentially complementary to the first engagement element in terms of shape and size, wherein the two engagement elements are in a mechanical operative connection with one another and thus block a rotation of the stator of the rotor position sensor device about the axis of rotation of the rotor shaft.

In particular, the first engagement element is an axial overhang of the holding element, which engages in a second engagement element formed as a recess on the stator of the rotor position sensor device.

Furthermore, the holding element can have radially projecting tabs for implementing the mechanical fixation to the static element.

In particular, the tabs can project from a radially inner ring region formed by the holding element.

The tabs can have openings or even holes through which screw connections with the static element are implemented. The design of the holding element with radially projecting tabs results in a reduced weight of the holding element compared to a closed circular ring shape.

Another aspect is a method for producing an electric rotation machine, in which a rotor of a rotor position sensor device is arranged on a rotor shaft, a stator of the rotor position sensor device is arranged on a static element, and a holding element is mechanically fixed to the static element so that the holding element blocks the translational degree of freedom of the stator of the rotor position sensor device in a first axial direction and the translational degree of freedom of the stator of the rotor position sensor device is blocked by the static component in the opposite axial direction.

In this regard, the stator of the rotor position sensor device can be arranged in a radially formed shoulder of the static element so that a surface of the shoulder arranged in a radially aligned plane blocks the translational degree of freedom of the stator of the rotor position sensor device in the opposite axial direction, and in this way the holding element together with the static element itself provides for the axial fixation of the stator of the rotor position sensor device; and an axially aligned cylindrical surface of the shoulder blocks the translational degree of freedom of the stator of the rotor position sensor device in the radial direction.

The holding element can be mechanically fixed, in particular screwed, to the static element.

One or more axial projections on the holding element can be used for axial tolerance compensation of the axial tolerance chain formed by the static element and the stator of the rotor position sensor device.

The first engagement element and the second engagement element can be brought into a mechanical operative connection with one another and thus block a rotation of the stator of the rotor position sensor device about the axis of rotation of the rotor shaft.

In addition, a drive system for a motor vehicle, in particular an electric axle, is provided, which comprises at least one electric rotation machine as described.

### BRIEF DESCRIPTION OF THE DRAWINGS

The disclosure described above is explained in detail below against the concerned technical background with reference to the accompanying drawings, which show preferred embodiments. The disclosure is in no way limited by the purely schematic drawings, wherein it should be noted that the exemplary embodiments shown in the drawings are not limited to the dimensions shown. In the figures:

FIG. 1: shows a conventional rotor position sensor device designed as an external rotor,

FIG. 2: shows a conventional rotor position sensor device designed as an internal rotor,

FIG. 3: shows a rotor position sensor device designed as an internal rotor,

FIG. 4: shows a holding element in a perspective view,

FIG. 5: shows a rotor position sensor device with a holding element arranged thereon,

FIG. 6: shows a partial region of the electric rotation machine in a sectional view with a rotor position sensor device during assembly,

FIG. 7: shows a partial region of the electric rotation machine in a sectional view with a rotor position sensor device after assembly,

FIG. 8: shows a partial region of the electric rotation machine in a view from outside,

FIG. 9: shows a rotor position sensor device with second engagement elements,

FIG. 10: shows a holding element in a further embodiment in a perspective view,

FIG. 11: shows a rotor position sensor device with a holding element of the further embodiment arranged thereon,

FIG. 12: shows a partial region of the electric rotation machine in a sectional view with a rotor position sensor device during assembly,

FIG. 13: shows a partial region of the electric rotation machine in a sectional view with a rotor position sensor device after assembly, and

FIG. 14: shows a partial region of the electric rotation machine in a view from outside.

### DETAILED DESCRIPTION

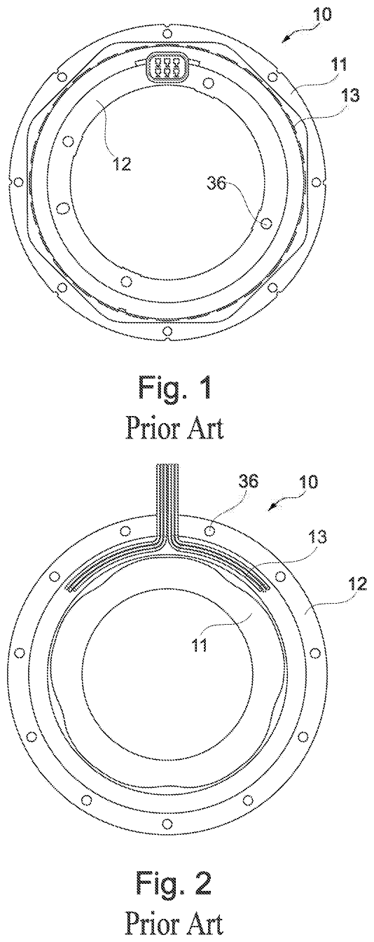

FIGS. 1 and 2 have already been discussed for the purpose of explaining the prior art.

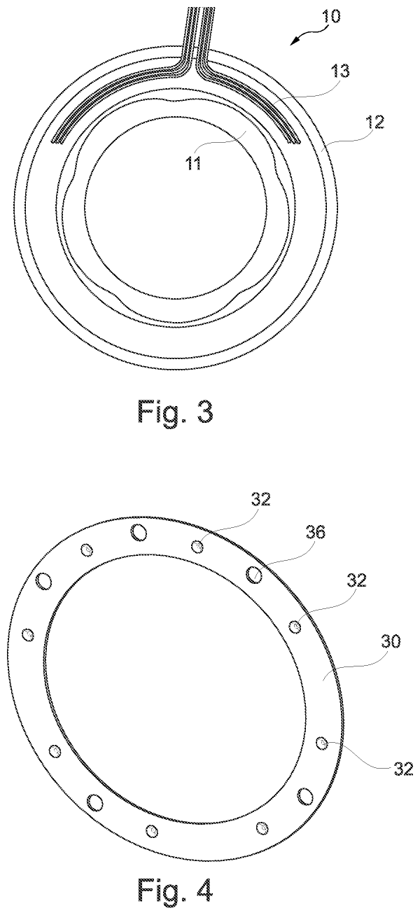

FIG. 3 shows a rotor position sensor device 10, which is designed as an internal rotor, so that consequently the rotor 11 of the rotor position sensor device 10 is arranged radially inside the stator 12 of the rotor position sensor device 10 and also its coils 13.

A holding element 30, as shown in FIG. 4, is used to position and fix the rotor position sensor device 10.

This holding element 30 is designed to be essentially annular in shape and has a plurality of openings 36 evenly distributed around its circumference for mechanical fixation. Furthermore, it also comprises axial projections 32 evenly distributed around the circumference.

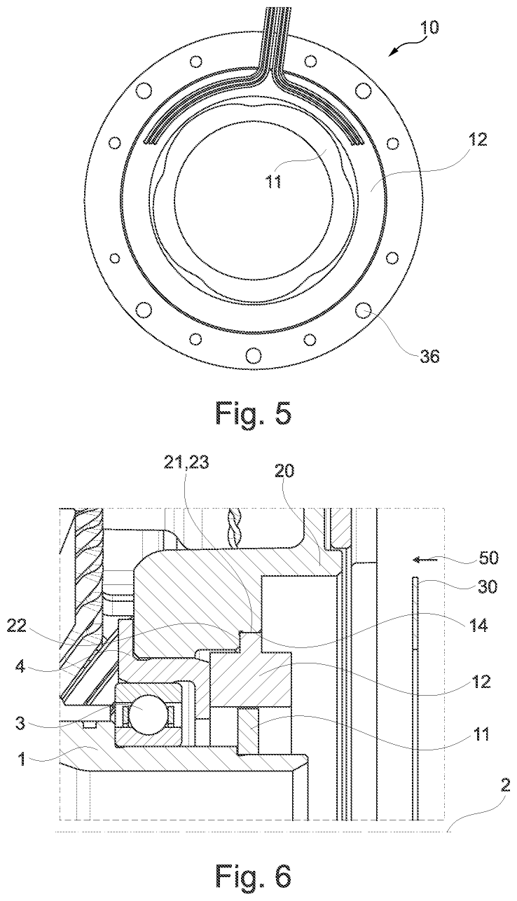

FIG. 5 shows an axial view of the rotor position sensor device 10, the stator 12 of which is overlaid by the holding element 30 in regions.

FIG. 6 shows a partial region of the electric rotation machine in a sectional view prior to assembly of the holding element 30.

It can be seen here that a rotor shaft 1 of the electric rotation machine is present, which, mounted by a rotation bearing 3, is rotatable about an axis of rotation 2.

The rotation bearing 3 is supported by an intermediate element 4 on a static element 20, which can in particular be the stator 12 of the electric rotation machine or also a housing of the electric rotation machine.

The rotor 11 of the rotor position sensor device 10 sits on the rotor shaft 1. The stator 12 of the rotor position sensor device 10 is arranged with a partial region in a shoulder 21 of the static element 20. This shoulder 21 is designed to be essentially cylindrical in shape, so that it has a surface 22 arranged in a radially aligned plane and an axially aligned cylindrical surface 23.

The stator 12 is radially supported on the axially aligned cylindrical surface 23 and is thus simultaneously centered in relation to the axis of rotation 2.

To assemble the holding element 30, it is placed axially against the static element 20 in the assembly direction 50 shown and also against the stator 12 of the rotor position sensor device 10.

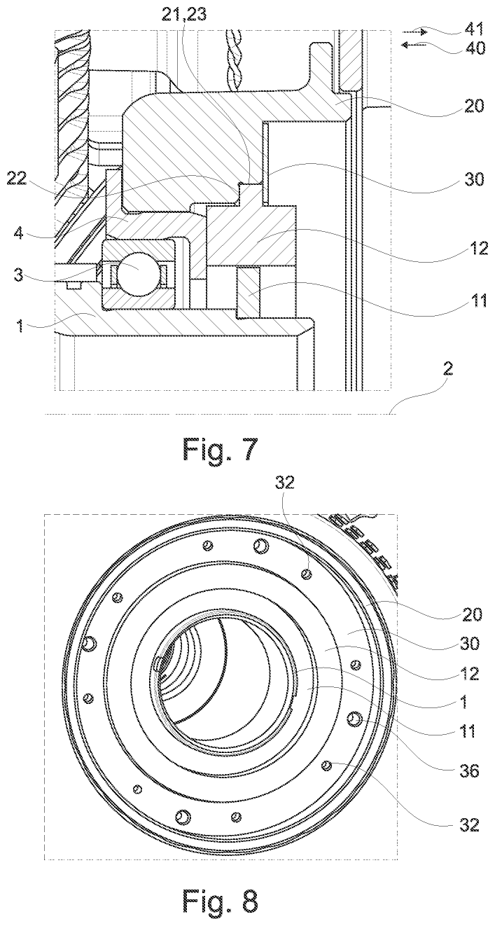

This state is shown in FIG. 7. It can be seen that the holding element 30 bears flat against the static element 20 and also against the stator 12.

The holding element 30 blocks the translational degree of freedom of the stator 12 in a first axial direction 40. In the opposite axial direction 41, the translational degree of freedom of the stator 12 is blocked by the static element 20.

This position of the holding element 30 can also be seen in the perspective view in FIG. 8. Screw connections can now be implemented through the openings 36, which fix the holding element 30 to the static element 20.

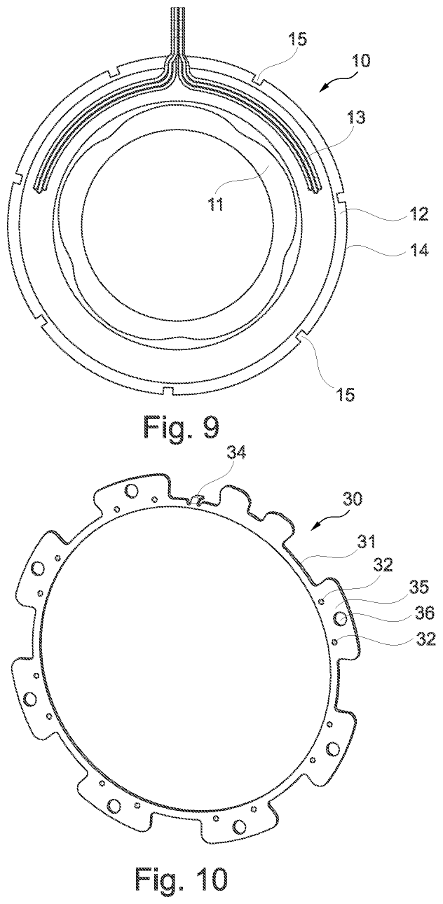

FIGS. 9-14 show a rotor position sensor device 10 and also a holding element 30 in alternative embodiments.

FIG. 9 shows that the stator 12 of the rotor position sensor device 10 has second engagement elements 15 in the form of recesses on its radial outer side 14.

The holding element 30 shown in FIG. 10 comprises a first engagement element 34, which is designed as an axial overhang. The first engagement element 34 is designed to axially engage the second engagement element 15, thereby preventing a relative rotational movement of the stator 12 of the rotor position sensor device 10 in relation to the holding element 30.

In addition, it can be seen in FIG. 10 that the holding element 30 in the embodiment shown here has tabs 35 projecting radially outward from a radially inner ring region 31. An opening 36 and axial projections 32 are formed in each of these tabs 35.

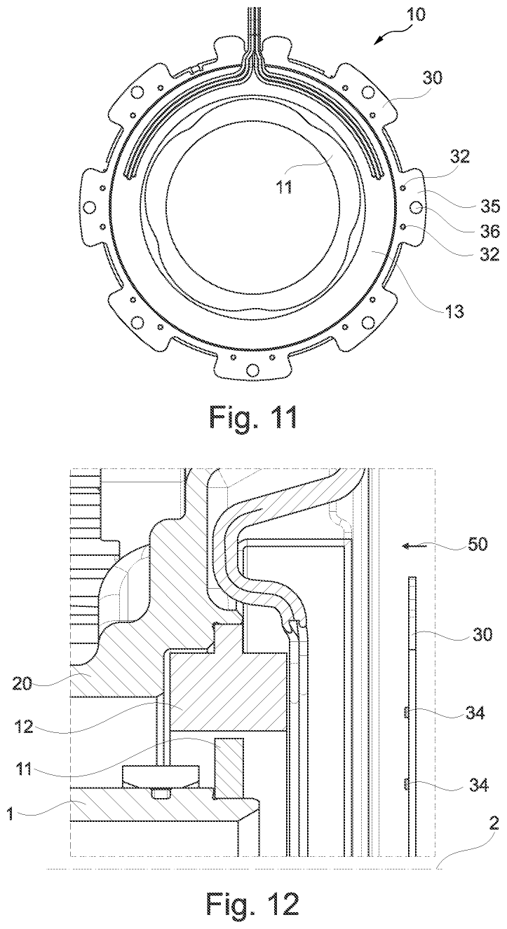

FIG. 11 shows a rotor position sensor device 10 equipped with the holding element 30 shown in FIG. 10.

Equivalent to FIG. 6, FIG. 12 shows a partial region of the electric rotation machine in a sectional view prior to assembly of the holding element 30 of this further embodiment. Here, a plurality of first engagement elements 34 can be seen on the holding element 30. Here, too, it is provided that the holding element 30 be placed against the stator 12 and the static element 20 in the assembly direction 50 shown.

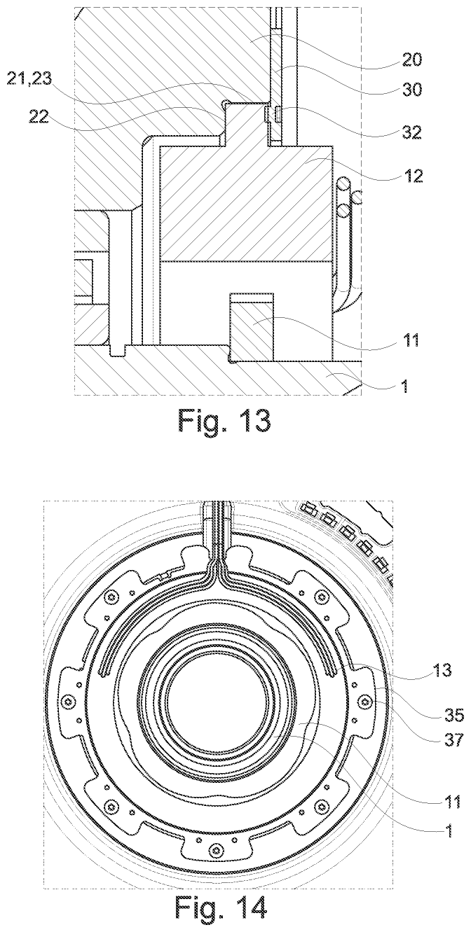

FIG. 13 shows the assembled state. Here, it is shown that an axial projection 32 of the holding element 30 has slightly deformed in the axial direction due to the bearing against and fixation of the holding element 30 to the static element 20.

The axial projection 32 serves to compensate for tolerances in the tolerance chain formed by the stator 12 and the static element 20. When the axial dimensions of the stator 12 and/or static element 20 are small, the axial projection 32 is subjected to essentially no axial length change.

However, if the stator 12 and/or the static element 20 have maximum axial dimensions within their tolerances, the axial projection is designed to compensate for this difference by deformation, so that it is ultimately ensured, irrespective of the actual axial dimensions, that when the holding element 30 bears against the static element 20, the holding element 30 also bears against the stator 12 of the rotor position sensor device 10 and consequently blocks the translational degree of freedom of the stator 12 in a first axial direction 40.

In the opposite axial direction 41, the stator 12 is blocked by the static element 20.

FIG. 14 shows this state in a view from the outside. Here it can also be seen that screw connections 37 pass through the openings 36 implemented in the tabs 35, which serve to fix the holding element 30 to the static element 20.

By virtue of the electric rotation machine, the method for producing the electric rotation machine, and the drive system proposed here, devices are provided which allow an inexpensive arrangement of the rotor position sensor device with the smallest possible required installation space and the lowest possible weight.

### LIST OF REFERENCE SYMBOLS

1 Rotor shaft
2 Axis of rotation
3 Rotation bearing
4 Intermediate element
10 Rotor position sensor device
11 Rotor
12 Stator
13 Coil
14 Radial outer side
15 Second engagement element
20 Static element
21 Shoulder
22 Surface arranged in a radially aligned plane
23 Axially aligned cylindrical surface
30 Holding element
31 Ring region
32 Axial projection
34 First engagement element
35 Radially projecting tab
36 Opening
37 Screw connection
40 First axial direction
41 Opposite axial direction
50 Assembly direction

1. An electric rotation machine, comprising:
a rotor shaft,
a rotor, which is arranged on the rotor shaft, of a rotor position sensor device,
a static element, on which a stator of the rotor position sensor device is arranged; and
a holding element, which is mechanically fixed to the static element and which blocks a translational degree of freedom of the stator of the rotor position sensor device in a first axial direction, wherein the translational degree of freedom of the stator of the rotor position sensor device is blocked by the static element in an opposite axial direction.

2. The electric rotation machine according to claim 1, wherein the stator of the rotor position sensor device is arranged at least in regions in a radially formed shoulder of the static element.

3. The electric rotation machine according to claim 2, wherein a surface of the shoulder arranged in a radially aligned plane blocks the translational degree of freedom of the stator of the rotor position sensor device in the opposite axial direction.

4. The electric rotation machine according to claim 2, wherein an axially aligned cylindrical surface of the shoulder blocks the translational degree of freedom of the stator of the rotor position sensor device in a radial direction.

5. The electric rotation machine according to claim 1, wherein the holding element is a metal sheet, which is mechanically fixed to the static element and which bears axially against the stator of the rotor position sensor device in regions.

6. The electric rotation machine according to claim 1, wherein the holding element has at least one axial projection with a compressive strength in an axial direction that is lower than a flexural strength of the holding element in a radius of an arrangement of the axial projection.

7. The electric rotation machine according to claim 1, wherein the holding element has a first engagement element and the stator of the rotor position sensor device has a second engagement element, which is complementary to the first engagement element in terms of shape and size, wherein the first and second engagement elements are in a mechanical operative connection with one another and thus block a rotation of the stator of the rotor position sensor device about an axis of rotation of the rotor shaft.

8. The electric rotation machine according to claim 1, wherein the holding element has radially projecting tabs for implementing the mechanical fixation to the static element.

9. A method for producing an electric rotation machine, the method comprising:
arranging a rotor of a rotor position sensor device on a rotor shaft;
arranging a stator of the rotor position sensor device on a static element;
fixing mechanically, a holding element to the static element so that the holding element blocks a translational degree of freedom of the stator of the rotor position sensor device in a first axial direction and the translational degree of freedom of the stator of the rotor position sensor device is blocked by the static element in an opposite axial direction.

10. A drive system for a motor vehicle, comprising:
at least one electric rotation machine, the electric rotation machine including:
a rotor shaft;
a static element;
a rotor position sensor device having a rotor arranged on the rotor shaft and a stator arranged on the static element; and
a holding element mechanically fixed to the static element, wherein the holding element blocks a translational degree of freedom of the stator in a first axial direction and the static element blocks the translational degree of freedom of the stator in an opposite axial direction.
